(19) United States
(12) Patent Application Publication
(10) Pub. No.: US 2010/0295362 A1
(43) Pub. Date: Nov. 25, 2010

(54) DEVICE AND METHOD FOR DETECTING A BRAKE OPERATION

(76) Inventors: Rafael Gonzalez Romero, Ilsfeld-Auenstein (DE); Frank Kaestner, Bietigheim-Bissingen (DE); Otmar Bussmann, Abstatt (DE)

Correspondence Address: KENYON & KENYON LLP, ONE BROADWAY, NEW YORK, NY, 10004, US

(21) Appl. No.: 12/863,823

(22) PCT Filed: Nov. 26, 2008
(86) PCT No.: PCT/EP2008/066186

§ 371 Date: Jul. 21, 2010

(30) Foreign Application Priority Data
Feb. 28, 2008 (DE) 10 2008 011 606.8

(51) Int. Cl. B60T 13/58; B60T 1/10; B60T 7/04; B60T 13/74; G01L 5/28

(52) U.S. Cl. 303/3; 188/152; 73/121

(57) ABSTRACT

A method for detecting the operation of a foot brake pedal of a motor vehicle brake system including a vacuum brake booster having a working chamber and a vacuum chamber. The operation of the brake pedal is able to be detected already during free travel if the pressure present in the working chamber and/or in the vacuum chamber is measured and the measured pressure or a pressure difference is evaluated.

### FIELD OF THE INVENTION

The present invention relates to a method for detecting a brake operation, a method for braking a vehicle, and a brake system for a vehicle.

### BACKGROUND INFORMATION

In hybrid vehicles, the electric machine is also used to convert the kinetic energy released in a braking operation into electrical energy and store it in the electrical system (so-called recuperation). The electrical power generated in this manner is thus available for a subsequent acceleration or for the operation of electrical consumers.

In these vehicles, the driver's braking intention is normally received using a pedal sensor on the foot brake pedal or in the brake booster. Force or deflection sensors are usually used as pedal sensors. Such pedal sensors are, however, relatively expensive.

### SUMMARY

An object of the present invention to detect the driver's braking intention using a simpler and more cost-effective sensor system. Furthermore, the sensor system of the present invention may be used to brake the vehicle exclusively regeneratively already during the free travel of the brake pedal.

One aspect of an example embodiment of the present invention is that in vehicles having a vacuum brake booster, the driver's braking intention is detected by measuring the pressure present in the working chamber and/or vacuum chamber of the brake booster and a brake pedal operation is detected (at least qualitatively) from the measured pressure or a pressure difference.

It has been shown that the chamber pressure changes already during the free travel of the brake pedal, i.e., even before a brake pressure has built up in the brake master cylinder. It is thus already possible to detect a pedal operation during the free travel of the brake pedal. Therefore, the electric machine is able to be used already during the free travel of the brake pedal to generate electrical power and brake the vehicle exclusively by operating it as a generator.

The measured pressure is preferably processed by a control unit. The control unit is connected with the electric machine or a control and regulating unit of the electric machine and controls it as a function of the measured pressure or the pressure difference.

According to a particular specific embodiment of the present invention, as soon as a pedal operation is detected, the electric machine is initially operated using a first (e.g., mean) generator power, and the generator power is increased as the pedal operation is increased.

An example brake system according to the present invention for a vehicle includes at least one hydraulic friction brake having a vacuum brake booster as well as an electric machine that produces a predefined brake torque during generator operation. Moreover, a sensor system for measuring the pressure present in the working chamber and/or in the vacuum chamber is provided as well as a device, e.g., a control unit, which detects a pedal operation based on the measured pressure or a pressure difference. In a favorable case, the brake system does not include a separate pedal sensor.

According to a preferred specific embodiment of the present invention, pressure sensors are situated in both chambers of the vacuum brake booster. In this case, the pedal operation is preferably determined based on the pressure difference.

### BRIEF DESCRIPTION OF THE DRAWINGS

The present invention will be explained in greater detail below with reference to example embodiments and the figures.

FIG. 1 shows a schematic representation of a motor vehicle brake system including a hydraulic brake and a generator.

FIGS. 2a-2c show the curve of various pressures and signals in a braking operation.

FIG. 3 shows the proportion of the hydraulic service brake and of the generator in the deceleration of the vehicle.

### DETAILED DESCRIPTION OF EXAMPLE EMBODIMENTS

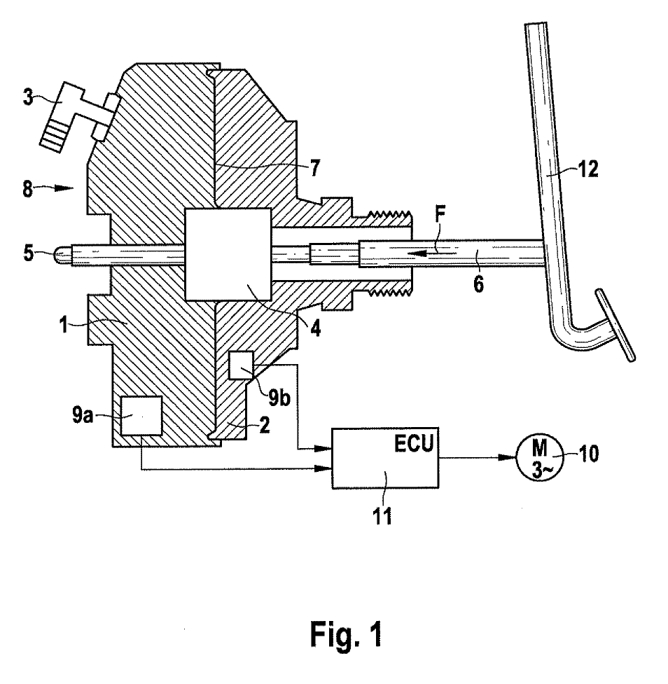

FIG. 1 shows a schematic representation of a motor vehicle brake system including a hydraulic brake system (components 8, 12) and an electric machine 10 which applies a predefined brake torque during generator operation. The hydraulic brake includes a vacuum brake booster 8 (UBKV) including a working chamber 2 and a vacuum chamber 1 having a vacuum connection 3.

A membrane 7 is situated between the two chambers 1, 2. A vacuum source (not shown) is connected to vacuum connection 3 of vacuum chamber 1, the vacuum source being driven, e.g., by the internal combustion engine and generating a predefined vacuum in vacuum chamber 1.

Furthermore, a double valve 4 is situated in the center area of vacuum brake booster 8, the double valve fulfilling two functions, namely a) separating working chamber 2 from vacuum chamber 1 or joining the two chambers 1, 2 to one another, and b) supplying ambient air to working chamber 2 or separating it from the ambient air.

In the unbraked state, the connection between vacuum chamber 1 and working chamber 2 is open. An identical vacuum is thus present in both chambers 1, 2. If foot brake pedal 12 is operated, the two chambers 1, 2 are separated from one another and working chamber 2 is ventilated from the outside.

As a function of brake force F applied via brake rod 6, a pressure difference occurs between the two chambers 1, 2. The force on working membrane 7 resulting from the pressure difference boosts brake force F. After force F is released, the supply of ambient air is interrupted and chamber valve 4 is reopened. This causes a vacuum to be applied to both chambers 1, 2 from the vacuum source.

To detect a pedal operation of foot brake pedal 12, two pressure sensors 9a, 9b are provided. Sensor 9a is situated in vacuum chamber 1 and sensor 9b is situated in working chamber 2. The sensor signals are evaluated by a control unit 11. An algorithm stored in control unit 11 is able to detect an operation of brake pedal 12, either based on one of the pressure signals or based on a pressure difference, depending on the specific embodiment.

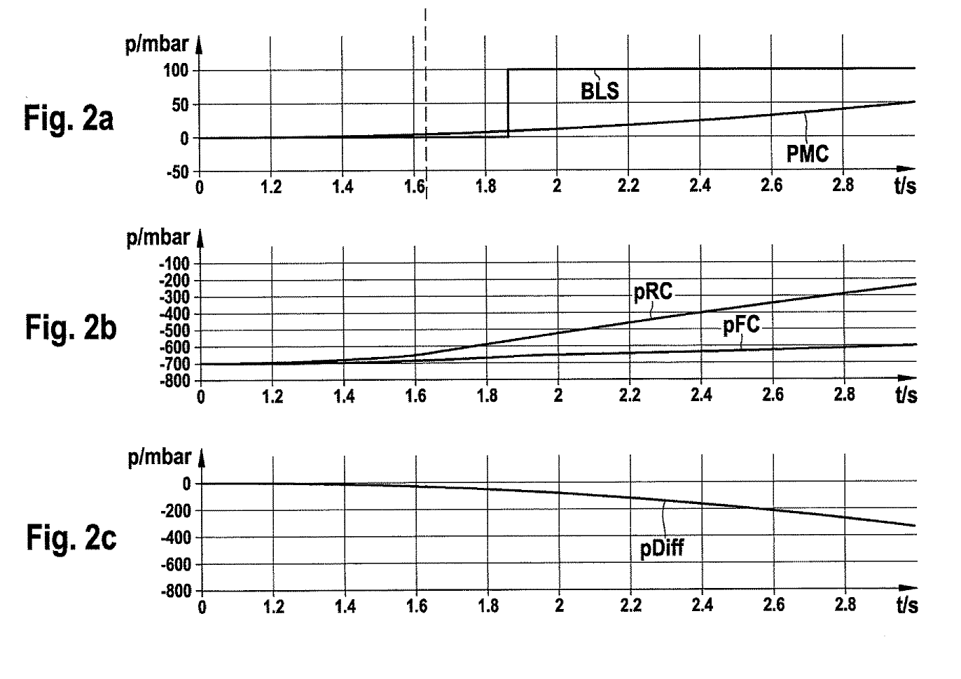

FIGS. 2a-2c show the pressure curve in the two chambers 1, 2 during a braking operation, and the pressure in the brake master cylinder of the hydraulic brake system.

FIG. 2a shows pressure curve pMC in the brake master cylinder during a braking operation. Starting from point in time t=0 s, brake pedal 12 is increasingly operated. As is apparent, starting from approximately 1.6 s, a pressure builds up in the brake master cylinder (see dashed line). The friction brake becomes active from this point in time. Before this point in time, the pedal travel is designated as “free travel.” From the point in time of approximately 1.9 s, signal BLS of the brake light switch is activated.

FIG. 2b shows the curve of working chamber pressure pRC and vacuum chamber pressure pFC (RC: rear chamber, FC: front chamber). As is apparent, the pressure in both chambers 1, 2 changes already during the free travel of brake pedal 12. In the present example, an increase in the chamber pressure is already evident starting at approximately 1.4 s. Control unit 11 is thus able to detect an operation of the brake pedal already during the free travel using chamber pressure pRC or pFC or using a pressure difference such as is shown in FIG. 2. Because of the greater sensitivity of signals pRC and of difference signal pDiff, these signals are best suited for the detection. Thus, electric machine 10 may be used already during free travel to decelerate the vehicle.

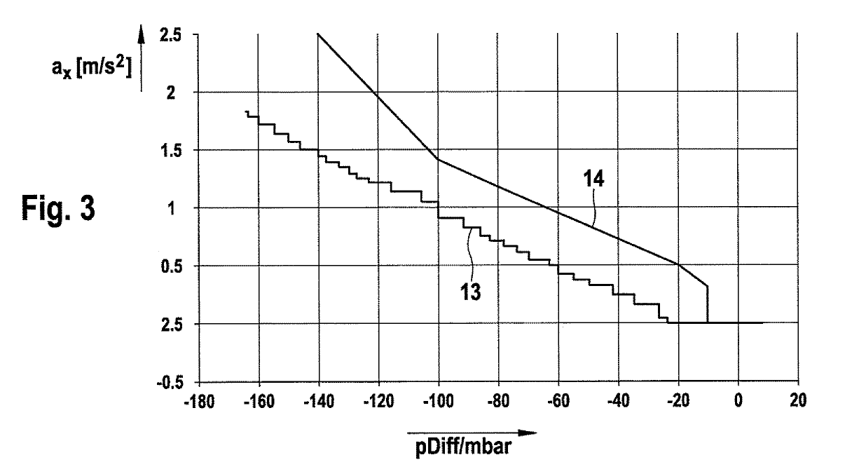

FIG. 3 shows the proportion of the hydraulic service brake and of generator 10 in decelerating the vehicle during a braking operation. Characteristic curve 13 denotes the deceleration by the service brake and characteristic curve 14 shows the additional deceleration by the brake torque of generator 10. In the pressure difference range between 0 mbar and −20 mbar, brake pedal 12 moves in free travel, i.e., the friction brake takes effect starting at approximately −20 mbar (see characteristic curve 13).

In the present exemplary embodiment, a pedal operation is detected at a brake pressure of approximately −10 mbar. From this point in time, electric machine 10 is activated in such a way that it produces a specific brake torque or a predefined mean electrical power. As the pressure difference increases, the electric machine is accordingly used to a greater degree.

The activation of electric machine 10 is performed by a control unit 11 (see FIG. 1).

1-6. (canceled)

7. A method for detecting an operation of a brake pedal of a brake system in a vehicle, the brake system including a vacuum brake booster having a working chamber and a vacuum chamber, the method comprising:
measuring a pressure present in at least one of the working chamber and the vacuum chamber; and
detecting a pedal operation based on one of the measured pressure or a pressure difference.

8. The method as recited in claim 7, wherein the chamber pressure is measured during free travel of the brake pedal before a brake pressure has built up in the brake system.

9. A method for braking a vehicle having a brake system operated using a brake pedal having a vacuum brake booster and an electric machine, the brake system applying a brake torque during generator operation, the brake booster having a working chamber and a vacuum chamber, the method comprising:
detecting an operation of the brake pedal based upon a measure of pressure in at least one of the working chamber and the vacuum chamber; and
operating the electric machine as a generator during a free travel of the brake pedal to brake the vehicle and generate electrical power if a pedal operation is detected.

10. A brake system for a vehicle, comprising:
a vacuum brake booster having a working chamber and a vacuum chamber;
a brake pedal for operating the brake system;
a sensor system measuring a pressure present in at least one of the working chamber and the vacuum chamber; and
a device which at least qualitatively detects an operation of the brake pedal from one of the measured pressure or a pressure difference.

11. The brake system as recited in claim 10, wherein no separate pedal sensor is provided.

12. The brake system as recited in claim 10, wherein the sensor system includes a pressure sensor both in the working chamber and in the vacuum chamber.
